(19) United States
(12) Patent Application Publication
(10) Pub. No.: US 2024/0280750 A1
(43) Pub. Date: Aug. 22, 2024

(54) Low-Cost, High-Performance Optoelectronic Connectors for Integrated Circuit Packaging

(71) Applicant: Massachusetts Institute of Technology, Cambridge, MA (US)

(72) Inventors: Drew Michael Weninger, Cambridge, MA (US); Anuradha M. AGARWAL, Weston, MA (US); Lionel C. KIMERLING, Concord, MA (US); Samuel Serna, Somerville, MA (US)

(21) Appl. No.: 18/444,287

(22) Filed: Feb. 16, 2024

Related U.S. Application Data
(60) Provisional application No. 63/485,717, filed on Feb. 17, 2023.

(51) Int. Cl. G02B 6/122; G02B 6/12

(52) U.S. Cl. CPC G02B 6/1228; G02B 2006/12061

(57) ABSTRACT

Die-to-die electrical interconnects, optical couplers, and related methods for electronic and photonic co-packaging are described. Optical couplers include multi-segmented tapered waveguide core segments, slotted core segments, and graded refractive index structures to significantly relax alignment tolerances between dies. Conductive nanopillars, conductive pads, and conductive micropillars can be used to make electrical connections between circuitry on the interconnected dies. The electrical connections can be used to self-align the optical couplers between the dies. Due to relaxed optical alignment tolerances, electrical interconnects and optical coupling between dies can be made in the same die-to-die bonding step.

### CROSS-REFERENCE TO RELATED APPLICATION(S)

The present application claims the priority benefit, under 35 U.S.C. 119(e), of U.S. Application No. 63/485,717, filed Feb. 17, 2023, which is incorporated herein by reference in its entirety.

### BACKGROUND

The co-packaging of optical or photonic integrated circuits and electronic integrated circuits provides a potential path forward to achieving high data rate communications. In a co-packaged design, the scaling of bandwidth, cost, and energy is governed by the number of optical transceivers (TxRx) per package as opposed to reduction in transistor size. Co-packaging of photonic integrated circuits and electronic integrated circuits can involve die-to-die electrical interconnects, die-to-die optical couplers, and fiber-to-die optical couplers.

### SUMMARY

The present disclosure relates to die-to-die and fiber-to-die optical couplers and to electrical interconnects that can be used on the dies with the optical couplers. The disclosure also relates to packaged devices that include multiple dies, die-to-die and fiber-to-die optical couplers, and electrical interconnects. Optical couplers described here include multi-segmented, tapered, evanescent optical couplers and graded refractive index (GRIN) couplers. The evanescent optical couplers can be used in combination with electrical interconnects described herein to achieve optical and electrical coupling from one semiconductor die to another semiconductor die, for example, in one bonding step. Additionally, or alternatively, the GRIN couplers can be used in combination with the electrical interconnects to achieve optical and electrical coupling from die-to-die in one bonding step with up to 10 microns or more of misalignment tolerance between die. Optical fiber-to-die coupling using at least one GRIN coupler and die-to-die optical coupling using two GRIN couplers can achieve high coupling efficiency with up to 10 microns or more of misalignment tolerance between the optical fiber and the GRIN coupler (for fiber-to-die coupling) or between the two GRIN couplers (for die-to-die coupling).

Some implementations relate to evanescent optical couplers comprising: a first tapered core segment optically coupled to a first single-mode optical waveguide at a first end of the first tapered core segment, wherein: the first tapered core segment has a first taper angle, the first taper angle defining a first angle at which a sidewall of the first tapered core segment angles toward a central axis of the first tapered core segment, and the first tapered core segment and the first single-mode optical waveguide are integrated onto or within a first die. Such optical couplers can further comprise a second tapered core segment optically coupled to the first tapered core segment at a second end of the first tapered core segment and integrated onto or within the first die, the second tapered core segment having a first terminating end that is not connected to another optical waveguide on the die, wherein the second tapered core segment has a second taper angle that is different than the first taper angle, the second taper angle defining an angle at which a sidewall of the second tapered core segment angles toward a central axis of the second tapered core segment.

Some implementations relate to slotted graded refractive index (GRIN) couplers comprising: a tapered core segment optically coupled to a single-mode waveguide; a slotted core segment optically coupled at a first end to the tapered core segment, the slotted core segment comprising a plurality of slotted voids formed in or through the slotted core segment; and a GRIN stack optically coupled at a first end to a second end of the slotted core segment, the GRIN stack comprising a plurality of layers of one or more materials, wherein at least two layers of the plurality of layers of one or more materials have different values of refractive index.

Some implementations relate to packaged devices having an optical fiber coupled to an integrated optical waveguide on a die. Such packaged devices can comprise: a first tapered graded refractive index (GRIN) coupler disposed on a substrate and optically coupled to the optical fiber at a narrow end of the first tapered GRIN coupler; and a second tapered GRIN coupler disposed on the die and optically coupled to the integrated optical waveguide at a narrow end of the second tapered GRIN coupler, wherein a wide end of the second tapered GRIN coupler is optically coupled to a wide end of the first tapered GRIN coupler and wherein the substrate is bonded to the die.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A depicts (in perspective view) an example of a multi-segmented evanescent optical coupler having multiple core segments with different taper angles.

FIG. 1B illustrates a plan view of the multi-segmented evanescent optical coupler of FIG. 1A.

FIG. 1C plots results from simulations of coupling efficiency as a function of misalignment of tapered core segments in the x, y, and z directions for the evanescent optical coupler of FIG. 1A.

FIG. 1D plots results from simulations of coupling efficiency as a function of rotational misalignment of tapered core segments for the evanescent optical coupler of FIG. 1A.

FIG. 2A depicts (in perspective view) an example of a slotted graded refractive index (GRIN) coupler comprising a slotted core segment along the GRIN coupler.

FIG. 2B illustrates the slotted GRIN coupler of FIG. 2A in elevation view.

FIG. 2C illustrates the slotted GRIN coupler of FIG. 2A in plan view with an enlarged view of the slotted core segment.

FIG. 2D depicts an enlargement of one-half of the slotted core segment.

FIG. 3A depicts (in perspective view) the use of two slotted GRIN couplers for vertically coupling optical energy between two waveguides, which could be used on a same die or between two dies in a flip-chip bonded arrangement.

FIG. 3B illustrates the two slotted GRIN couplers of FIG. 3A in a flip-chip, die-to-die, optical coupling arrangement in elevation view.

FIG. 3C plots optical intensity modeled for the die-to-die optical coupling arrangement of FIG. 3A and FIG. 3B.

FIG. 3D plots results from numerical simulations of coupling efficiency as a function of misalignment of GRIN couplers in the x and y directions for the optical coupling arrangement of FIG. 3A and FIG. 3B.

FIG. 3E plots results from numerical simulations of coupling efficiency as a function of misalignment of GRIN couplers in the z direction for the optical coupling arrangement of FIG. 3A and FIG. 3B.

FIG. 4A illustrates optical and electrical die-to-die coupling in a flip-chip coupling arrangement that uses conductive nanopillars without solder to establish die-to-die electrical connections.

FIG. 4B illustrates optical and electrical die-to-die coupling in a flip-chip coupling arrangement that uses micro-scale contact pads and a thin conductive film to establish die-to-die electrical connections.

FIG. 5 illustrates optical and electrical die-to-die coupling in an implementation of flip-chip coupling that uses micropillars to establish die-to-die electrical connections.

FIG. 6A illustrates tapered GRIN couplers with relaxed alignment tolerances for edge coupling between single-mode optical waveguides on a die and single-mode optical fibers.

FIG. 6B is an elevation view of the optical coupling arrangement of FIG. 6A.

FIG. 7 depicts a portion of a package device comprising an electrical integrated circuit, a photonic integrated circuit, and an optical interposer that are electrically and/or optically coupled together.

### DETAILED DESCRIPTION

The inventors have recognized and appreciated that compact and efficient die-to-die electrical interconnects and optical couplers can increase the number and/or density of optical transceivers co-packaged together in a transceiver package. Die-to-die couplings that combine efficient, misalignment-tolerant optical couplers and electrical interconnects can provide a path forward to achieving top-of-rack switch packages with data rates of over 50 Tbps, allowing I/O to scale to Pbps magnitudes. Described herein are efficient optical couplers that include multi-segmented tapered cores and/or graded refractive index stacks to significantly relax alignment tolerances between dies. Also described are conductive micropillars, conductive nanopillars, and micro-scale conductive pads that can be used to make electrical interconnections between dies that are also optically coupled together with one or more of the optical couplers described herein. In some cases, the electrical interconnections established between the dies can be used to self-align the optical couplers between the dies. Due to relaxed optical alignment tolerances, electrical interconnects and optical coupling can be made in the same die-to-die bonding step.

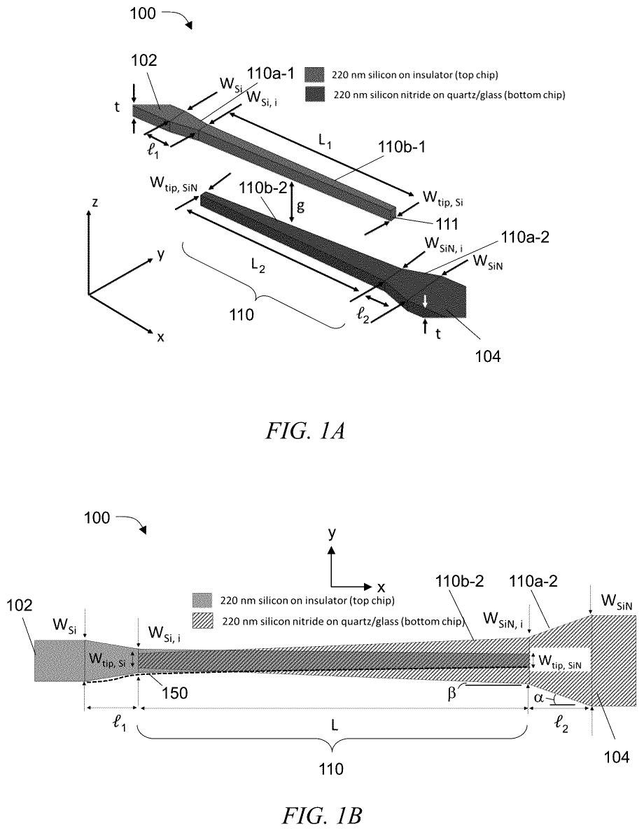

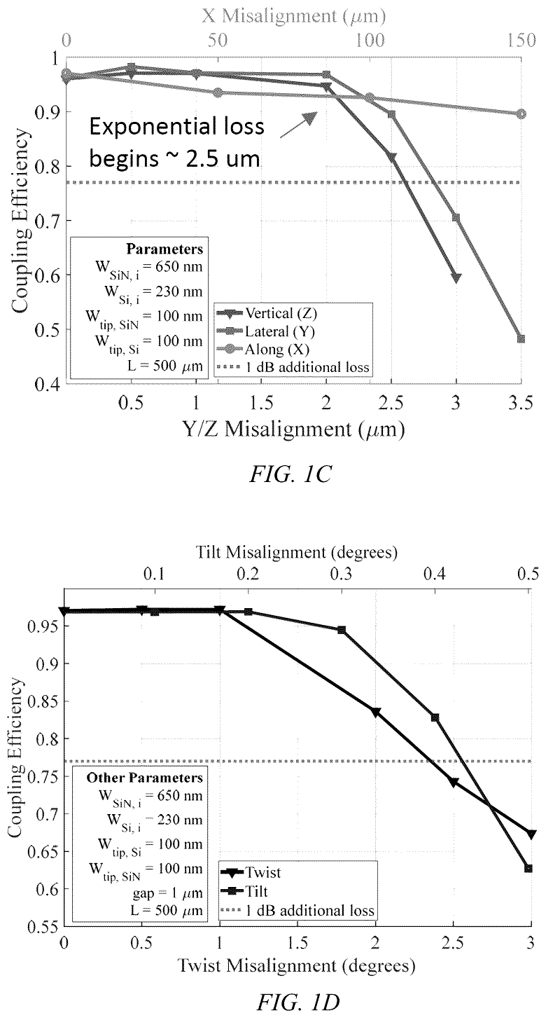

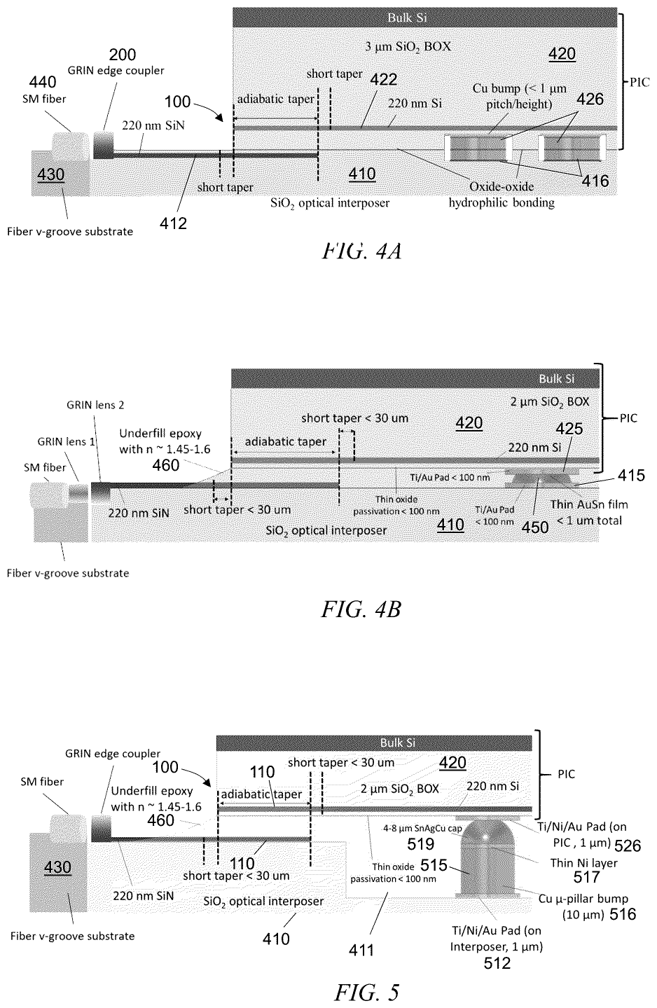

FIG. 1A and FIG. 1B depict an example of an evanescent optical coupler 100 that uses multi-segmented, tapered core segments 110a-1, 110b-1, 110a-2, 110b-2 connected to and forming ends of the two single-mode optical waveguides 102, 104. The waveguides 102, 104 (a portion of which is shown for each waveguide in the drawings) extend in the ±x directions indicated in the drawings. The first waveguide 102 and the tapered core segments 110a-1, 110b-1 can be disposed on a first die (e.g., as illustrated in FIG. 4A) and the second waveguide 104 and the tapered core segments 110a-2, 110b-2 can be disposed on a second die (also illustrated in the example of FIG. 4A) or can be disposed on the same first die for level-to-level optical coupling.

It will be appreciated by those knowledgeable in the art of integrated optics that the waveguides 102, 104 (and other integrated waveguides described below) each comprise a core (which can be the dark shaded rectangular structures shown in the drawing of FIG. 1A) having a first value of refractive index that is surrounded laterally (in the y and z directions of the drawing) by one or more materials having refractive index value(s) lower than the first refractive index value. Similarly, the tapered core segments 110a-1, 110b-1, 110a-2, 110b-2 can be surrounded laterally by one or more materials having refractive index value(s) lower than the refractive index value of the tapered core segments. The core of the waveguides 102, 104 and the tapered core segments can confine and guide the optical mode propagating along the waveguides 102, 104 and through a coupling region 110.

The long, tapered core segment 110b-1, 110b-2 define the coupling region 110 for coupling optical energy from one of the two waveguides 102, 104 to the other. For optical coupling, the central axes of each tapered core segment 110b-1, 110b-2 (which axes each run centrally in the core segments along their lengths L₁, L₂) are made parallel or approximately parallel to each other and the tapered core segments 110b-1, 110b-2 are brought to within a desired distance g from each other. Evanescent optical coupling can then occur between the two tapered core segments 110b, such that light propagating along the first waveguide 102 can couple into the second waveguide 104 through optical action along the coupling region 110.

The first waveguide 102 comprises a first material, which can be the same material as, or a different material than, the material used to form the second waveguide 104. In the illustrated example of FIG. 1A and FIG. 1B, the first waveguide comprises a silicon (Si) core and can be formed from a silicon layer of a silicon-on-insulator (SOI) wafer, for example. The second waveguide 104 can comprise a silicon nitride (SiN) or silicon oxynitride (SiON) core formed from a layer of SiN or SiON deposited on a glass, fused silica (SiO₂), or quartz substrate, for example. Other materials, wafers, and substrates can be used in other embodiments, including III-V semiconductor materials.

The first tapered core segment 110a-1 is optically coupled to (and may be directly connected to) the first waveguide 102. The second tapered core segment 110b-1 is optically coupled to (and may be directly connected to) the first tapered core segment 110a-1. A terminal end 111 of the second tapered core segment 110b-1 is not connected to another waveguide or core segment. In some implementations, a core of the first waveguide 102, the first core segment 110a-1, and the second core segment 110b-1 are formed from the same layer of material (e.g., silicon). A similar arrangement exists for the second waveguide 104. The core of the second waveguide 104 and its corresponding core segments 110a-2, 110b-2 can be formed from the same material as the core of the first waveguide 102 or a different material (e.g., silicon nitride or silicon oxynitride).

Some example dimensions of the waveguides 102, 104 and tapered core segments 110a-1, 110b-1, 110a-2, 110b-2 follow. The first waveguide 102 can be formed from silicon and have a height between 150 nm and 300 nm and a width W between 250 nm and 750 nm. The height and width of the waveguides can be selected based on the wavelength of light for which the device is designed and the materials used to form the waveguides. The length of the first tapered core segment 110a-1 connected to the first waveguide 102 can be from 10 microns to 40 microns. The width of the first tapered core segment 110a-1 can reduce from the width W of the first waveguide 102 at one end to an intermediate width Wᵢ having a value from 150 nm to 300 nm at an opposite end of the first tapered core segment 110a-1. The length of the second tapered core segment 110b-1 connected to the first waveguide 102 can be from 300 microns to 700 microns in some cases, or 300 microns to 1000 microns in some cases. The width of the second tapered core segment 110b-1 can reduce from the intermediate width Wᵢ of the first tapered core segment 110a-1 to a width Wₜᵢₚ at a terminal end or tip of the second tapered core segment 110b-1 having a value from 80 nm to 150 nm.

The second waveguide 104 can be formed from SiN or SiON and have a height between 150 nm and 500 nm and a width W between 700 nm and 1.5 microns (or even up to 3 microns for some compositions of SiON). The length of the first tapered core segment 110a-2 connected to the second waveguide 104 can be from 10 microns to 40 microns. The width of the first tapered core segment 110a-2 can reduce from the width W of the second waveguide 104 to an intermediate width Wᵢ having a value from 500 nm to 900 nm (or even up to 1.5 microns for some compositions of SiON). The length of the second tapered core segment 110b-2 connected to the second waveguide 104 can be from 300 microns to 700 microns in some cases, or from 300 microns to 1000 microns in some cases. The width of the second tapered core segment 110b-2 can reduce from the intermediate width Wᵢ of the first tapered core segment 110a-2 to a width Wₜᵢₚ at a terminal end or tip of the second tapered core segment 110b-2 having a value from 80 nm to 150 nm (or even up to 600 nm for some compositions of SiON).

In some cases, there can be more than two tapered core segments 110a-1, 110b-1, 110a-2, 110b-2 coupled to each waveguide 102, 104 in the evanescent optical coupler. The tapered core segments can have different taper angles along the optical coupler and have different lengths. The taper angles can be angles at which sidewalls of the core segment angle towards the central axis of the core segment (e.g., reducing the core segment's width (W_{Si} in the illustrated example) at one end of a tapered core segment 110a-1 to a smaller width (W_{Si,i}) at an opposite end of the tapered core segment 110a-1). The taper angles α, β (shown in FIG. 1B) can be in a range from 0.2 degree to 40 degrees.

A first tapered core segment 110a-1, 110a-2 can have a larger taper angle α and shorter length l₁, l₂ than taper angles β and lengths L₁, L₂ in remaining tapered core segments 110b-1, 110b-2. The larger taper angle and shorter length can rapidly expand the mode diameter exiting from a waveguide 102, 104, placing more of the optical energy in the evanescent field around the tapered core segments 110a-1, 110b-1, 110a-2, 110b-2. Alternatively, the larger taper angle and shorter length can rapidly reduce the mode diameter exiting the coupling region 110 and entering a waveguide 102, 104. The first tapered core segment 110a-1, 110a-2 can have length l₁, l₂ that is less than one-quarter the length of the remaining tapered core segments 110b-1, 110b-2 coupled to the waveguide. Because of the first coupling segment's rapid mode expansion, or reduction, the overall length of the evanescent optical coupler 100 can be reduced significantly compared to conventional evanescent couplers that use a single taper angle. For example, the overall length (L₁+l₁) of the evanescent optical coupler 100 can be from 400 microns to 600 microns, which is about a factor of two to four less than the length of conventional evanescent couplers using a single taper angle. Additionally, since the width of the evanescent optical coupler 100 is on the order of 2 microns or less, a plurality of evanescent optical couplers 100 can be arrayed side-by-side on a die with a pitch no greater than 10 microns in some cases.

In some implementations, instead of discrete taper angles along discrete tapered core segments, the tapered core segment can comprise a curved taper (indicated by the dashed curve 150 in FIG. 1B). The curved taper can provide an adiabatic tapering of the waveguide that reduces optical losses along the coupling regions (e.g., from scattering at abrupt inflection points where sidewalls having different taper angles meet).

The inventors have recognized and appreciated that die-to-die optical coupling can be challenging when sub-micron alignment is desired in multiple dimensions. For example, die bonders commonly found in high volume packaging usually have pick-and-place accuracies of 3-10 microns, which is insufficient for optical coupling techniques that require sub-micron alignment. The evanescent optical coupler 100, as described in connection with FIG. 1A and FIG. 1B, can relax alignment tolerances (e.g., in the x and y directions) between the tapered core segments 110b-1, 110b-2 in the coupling region 110 to 3 microns or more. Alignment distance in the z direction can be established with high accuracy (e.g., to one micron or less) via the microfabrication processes used on each die, since the two dies can contact each other when mounted together. For example, the two dies can be aligned in x and y and brought into contact (in the z direction) for coupling the dies together. The relaxing of alignment tolerances in the remaining directions makes the evanescent optical coupler 100 suitable for achieving optical coupling between waveguides on different dies using current high-speed, pick-and-place die bonders. Such evanescent optical couplers 100 can allow quality optical coupling between waveguides on different dies without solder self-alignment techniques intended to achieve sub-micron alignment. Such solder self-alignment techniques can be low yield in some cases.

All components of the evanescent optical coupler 100 can be fabricated using existing CMOS foundry processes making them suitable for adoption by integrated circuit manufacturers. For example, the waveguide cores can be formed from a layer of Si, SiN, or SiON having a thickness between 100 nm and 500 nm. Such layers are compatible with and used in CMOS processes. The minimum feature size of the evanescent optical coupler 100 can be no smaller than 80 nm, which can be patterned using standard CMOS processes (e.g., deep-ultraviolet photolithography).

FIG. 1C and FIG. 1D plot results of numerical simulations carried out to evaluate the effects of misalignment between the two second tapered core segments 110b-1, 110b-2 in the coupling region 110 for the evanescent optical coupler of FIG. 1A and FIG. 1B. FIG. 1C plots coupling efficiency as a function of misalignment of the two tapered core segments 110b-1, 110b-2 in the x, y, and z direction. Each curve is produced assuming alignment in position and rotation, except for the dimension varied to produce the curve. The long length of the second tapered core segments 110b-1, 110b-2 allows for greater misalignment in the x direction (e.g., up to 150 microns of misalignment with less than 1 dB of added coupling loss). Alignment tolerances in the transverse directions (y and z in the illustrated example) can be over 2.5 microns before incurring about 1 dB of added coupling loss. The tolerance for transverse misalignment is about a factor of 10 larger than conventional single-taper evanescent optical couplers between silicon waveguides.

FIG. 1D plots coupling efficiency as a function of rotational misalignment in tilt or pitch (rotation about the y axis) and twist or yaw (rotation about the z axis). Over 2 degrees of rotational alignment error in yaw can be tolerated before incurring about 1 dB of added coupling loss. Over 0.4 degrees of tilt misalignment can be tolerated before incurring about 1 dB of added coupling loss.

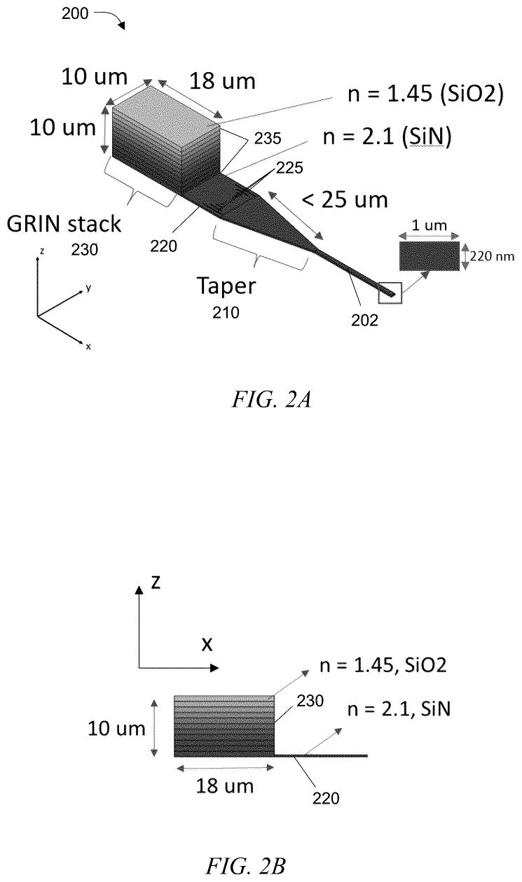

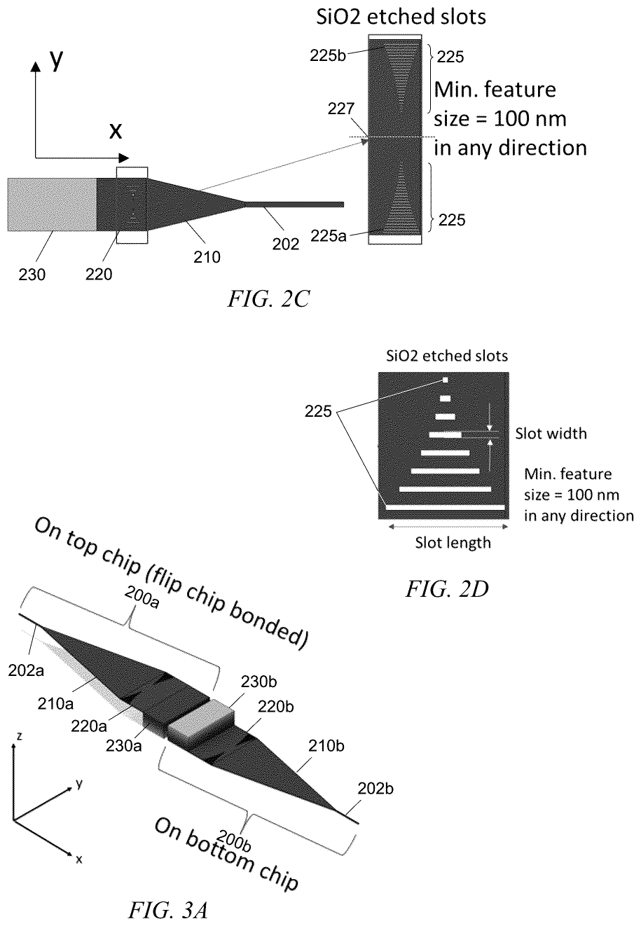

FIG. 2A depicts (in perspective view) an example of a slotted graded refractive index (GRIN) coupler 200 that can be used to couple a single-mode optical waveguide 202 disposed on a die to an optical fiber (not shown in the drawing) that has an end positioned adjacent to the slotted GRIN coupler 200, or to another GRIN coupler disposed on another die (for coupling into a single-mode integrated optical waveguide, for example). The example slotted GRIN coupler 200 comprises a tapered core segment 210 optically coupled at a narrow end to the optical waveguide 202 and optically coupled at an opposite end to a slotted core segment 220. The slotted core segment is optically coupled at a distal end (opposite the end coupled to the tapered core segment 210) to a GRIN stack 230. The slotted core segment 220 includes a plurality of slotted voids 225 formed in the core of the slotted core segment 220. These slotted voids 225 are shown in further detail in the drawings of FIG. 2C and FIG. 2D. The slotted voids 225 can be filled with material of lower refractive index (e.g., an oxide deposited around the slotted core segment 220 that may also function as cladding material around the slotted core segment and tapered core segment 210). An example of the slotted GRIN coupler incorporated on a die is shown in FIG. 4A.

In some implementations, the tapered core segment 210 can be directly connected to the core of the single-mode optical waveguide 202. The slotted core segment can be directly connected to the tapered core segment 210, and the GRIN stack 230 can be directly connected to the slotted core segment 220. In some cases, the core of the single-mode optical waveguide 202, the tapered core segment 210, the slotted core segment 220, and a layer of the GRIN stack are formed from a single layer of material (e.g., Si, SiN, or SiON).

Referring to FIG. 2A, an optical mode traveling in the −x direction can be launched into free space or other material after passing through the GRIN stack 230. Conversely, an optical mode traveling in the +x direction and aligned with the GRIN stack 230 can be received from free space or another material and couple into the GRIN stack 230, slotted core segment 220, tapered core segment 210, and then into the optical waveguide 202.

The slotted voids 225 provide lensing action in the ±y directions to rapidly reduce, or expand, the optical mode passing through the slotted core segment 220, depending on the direction of travel. An optical mode traveling toward the GRIN stack 230 will be rapidly expanded in the ±y directions by the slotted voids 225. The assistance in mode expansion, or reduction, caused by the slotted voids allows the tapered core segment 210 to be significantly shortened (e.g., by about a factor of three compared to conventional tapered waveguides).

The GRIN stack 230 can be formed by depositing multiple layers 235 of hard, inorganic materials (such as oxides, silicon oxides, and/or silicon oxynitrides) having different refractive index values. There can be from 10 to 30 layers in the GRIN stack 230. The refractive index value of one or more layers in the GRIN stack 230 can be highest near the slotted core segment 220 (e.g., near the surface of the die on which the waveguide 202 is disposed) and reduce to a lower refractive index value with each successive deposited layer (in the +z direction of the drawing). In the illustrated example, a layer near the surface of the die can have an index value of 2.1 and a layer of the GRIN stack 230 farthest from the surface can have an index value of 1.45. Other index values and ranges are possible.

In some cases, layers of polymers can be used to form the GRIN stack 230. In some implementations, the layers of the GRIN stack 230 comprise at least one polymer layer, which layer or layers can be deposited by spin-coating. After the layers 235 are formed on the substrate, the shape of the GRIN stack (extent in x and y directions in the drawing) and location can be patterned and etched using photolithography processes, for example.

The lateral size of the GRIN stack 230 can be small (e.g., extending no more than 20 microns in any direction parallel to the surface of a die on which the GRIN stack 230 is disposed, the x and y directions in the illustrated example of FIG. 2A). In some implementations, the maximum lateral extent of the GRIN stack 230 can be no greater than 15 microns, no greater than 30 microns, or no greater than 50 microns. The height of the GRIN stack 230 (in a direction perpendicular to the surface of a die on which the GRIN stack 230 is disposed, z direction in this illustration) can be no greater than 5 microns in some implementations, no greater than 10 microns in some implementations, no greater than 15 microns in some implementations, and no greater than 20 microns in some implementations.

The slotted core segment 220 and GRIN stack 230 can reduce the length of the tapered core segment 220 (from over 75 microns long in a conventional tapered coupler to less than 25 microns), still achieving high-efficiency optical coupling. The overall length of the GRIN coupler 200 (from the narrow end of the tapered core segment 210 to the farthest end of the GRIN stack) can be from 40 microns to 75 microns in some implementations. In some implementations, the tapered core segment 210 can have a length from 10 microns to 40 microns or any subrange therebetween. The length of the slotted core segment 220 can be from 5 microns to 15 microns or any subrange therebetween. The coupling efficiency of the GRIN coupler 200 to a single mode optical fiber or to another GRIN coupler can be from 50% to 95% in some cases or any subrange therebetween (e.g., from 60% to 85% in some cases).

When polymer layers 235 are used to form the GRIN stack 230, different polymers, additives or additive quantities, and/or bake times can be used to obtain different refractive index values. Alternatively, or additionally, different optical curing times and/or different processing treatments (such as bake times) of the polymer layers can establish different refractive index values for different polymer layers in the GRIN stack 230. For example, the refractive index can be a function of an optical dose used to expose and/or cure at least one polymer layer in the GRIN stack 230.

In operation, the slotted GRIN coupler 200 is bidirectional as described above. Light can enter or exit from either the optical waveguide 202 or the GRIN stack 230 without needing to change the design or structure of the GRIN coupler 200. When an optical mode enters the GRIN stack 230 (from an optical fiber (not shown) which can butt-couple to the GRIN stack 230), the optical mode begins to oscillate with a focal length equal to or approximately equal to the length of the GRIN stack 230. The focal length for the GRIN stack 230 is for focusing the optical mode in a direction that is perpendicular to the surface of the die on which the GRIN stack 230 is disposed or perpendicular to the broad surfaces of the layers 235 making up the GRIN stack 230 (z in the illustration of FIG. 2A). When the optical mode reaches the end of the GRIN stack 230, the mode's transverse spatial extent (in the z direction for the illustrated example) is reduced to a minimum or small value so that the optical mode can be coupled efficiently into the slotted core segment 220 (which can comprise a single layer of waveguide material (e.g., a SiN or SiON layer).

The optical mode in the slotted core segment 220 is highly elliptical (e.g., thin in the z direction and wide in the y direction of the illustration) but can be reduced laterally (in the y directions) by the slotted core segment 220 and tapered core segment 210 for efficient coupling into the narrower optical waveguide 202. As the optical mode encounters the slotted voids 225, which are formed in the waveguide core of the slotted core segment 220, the slotted voids 225 cause lensing action in the slotted core segment 220 to focus the light into the single mode optical waveguide 202 that abuts and is optically coupled to the narrow end of the tapered core segment 210. The optical mode can then efficiently couple into the optical waveguide 202, which can then route the optical mode on the die on which the GRIN coupler 200 and optical waveguide 202 are disposed. The die on which the slotted GRIN coupler 200 is disposed can comprise a photonic integrated circuit, an electronic integrated circuit, or an optical interposer, for example. FIG. 4A depicts the slotted GRIN coupler 200 implemented on an optical interposer die.

In some implementations, the optical waveguide 202 can further provide optical coupling to another optical waveguide on the same die or on a different die. For example, the optical waveguide 202 may comprise, at some location along its length, an evanescent optical coupler 100 depicted in FIG. 1A that is used to couple to another optical waveguide on the same die or on a different die.

The slotted GRIN coupler 200 of FIG. 2A can be patterned using a lithography process that has an overall alignment error as large as 500 nm, because high-precision mask alignment of the tapered core segment 210 and slotted core segment 220 (which can be patterned at the same time) to the GRIN stack 230 is not necessary when patterning the GRIN stack 230. For example, the width of the slotted core segment can be up to 10 microns or more, such that a 500 nm misalignment (in the y direction in the drawings) between the GRIN stack 230 and slotted core segment 220 does not significantly reduce the coupling efficiency between the slotted core segment 220 and the GRIN stack 230.

FIG. 2B illustrates the GRIN stack 230 of FIG. 2A in elevation view. An example height (10 microns) and length (18 microns) are shown in the drawing. FIG. 2C illustrates the slotted GRIN coupler 200 of FIG. 2A in plan view with an enlarged view of a portion of the slotted core segment 220. The slotted voids 225 have different lengths across the width of the slotted core segment 220, being longer closer to the edges of the slotted core segment 220. There can be from 6 to 30 slotted voids distributed across the slotted core segment 220. The smallest dimension of the slotted voids can be about or no less than 100 nm in some cases, or no less than 80 nm in some cases.

The slotted voids 225 can comprise pairs of slotted voids. One slotted void 225a of a pair of slotted voids is disposed on one side of the central axis 227 of the slotted core segment 220 and the other slotted void 225b of the pair of slotted voids is disposed on the other side of the central axis 227. Each slotted void of a pair of slotted voids can have a same length or approximately same length and be disposed equal or approximately equal distances from the central axis 227 of the slotted core segment 220. A first length of slotted voids in a first pair of slotted voids can differ from a second length of slotted voids in a second pair of slotted voids. The slotted voids 225 can be arranged across the slotted core segment 220 to focus an optical mode traveling from the GRIN stack 230 through the slotted core segment 220 into the tapered core segment 210.

FIG. 2D depicts an enlargement of one-half of the slotted core segment 220, showing a smaller number of slotted voids. The number and placement of slotted voids 225 can be selected to alter the focusing properties of the slotted core segment 220. In the illustrated example, the width of each slotted void is 100 nm, though larger or smaller widths are possible. The pitch of the slotted voids can range from 150 nm to 700 nm, for example. In some cases, the slotted voids 225 can have different widths across the slotted core segment 220. The length of the shortest slotted void can be equal to the width of the shortest slotted void (100 nm in the illustrated example). The length of the longest slotted void can be many times the width of the longest slotted void. For example, the longest slotted void can be up to 2 microns or more in length.

According to one example implementation, there are 12 slotted voids distributed across the slotted core segment 220. Each slotted void has a width of about 100 nm. The shortest slotted void in or nearest the middle of the slotted core segment 220 has a length of about 300 nm. The longest slotted void near the edge of the slotted core segment 220 has a length of about 6 microns.

The slotted GRIN coupler 200 is also compatible with multi-level alignment CMOS microfabrication processes. For example, existing CMOS processes are capable of patterning features sizes down to 100 nm or less. Additionally, multi-level mask alignment accuracies in CMOS processes can be significantly less than 500 nm (e.g., down to 100 nm or less). The waveguide 202 can be formed from a thin layer of Si, SiN, or SiON (e.g., a 100 nm to 500 nm thick layer), which are also compatible with CMOS processing. The multiple layers 235 can be formed from hard inorganics (described above) that are compatible with CMOS processing.

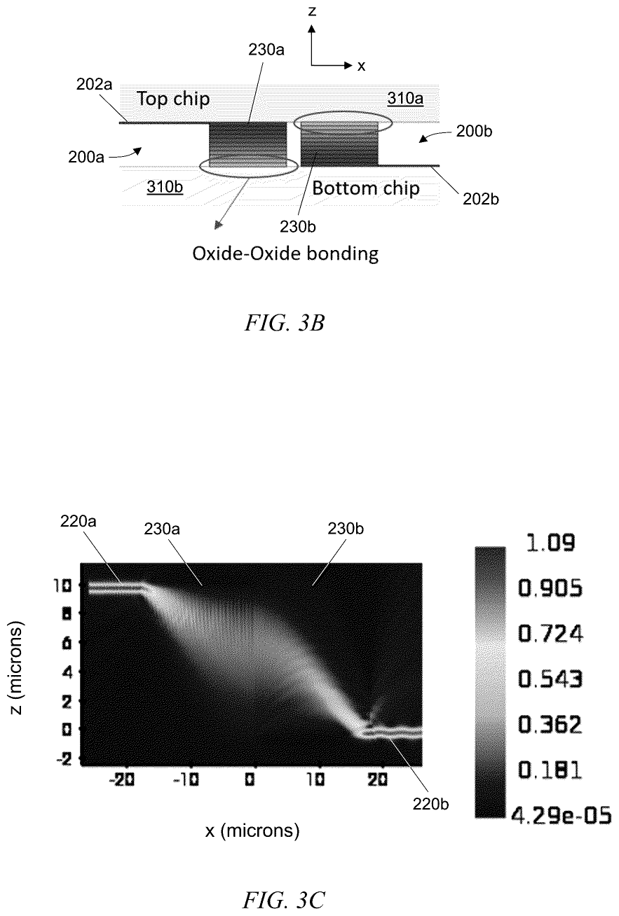

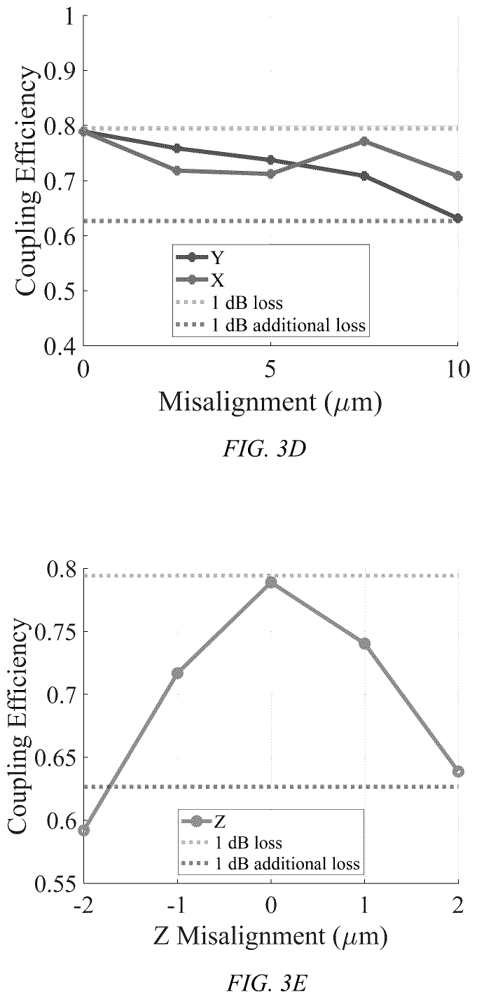

FIG. 3A depicts (in perspective view) two slotted GRIN couplers 200a, 200b that can be used for vertical optical coupling between two waveguides 202a, 202b disposed on the same or different dies. The first GRIN coupler 200a can be disposed on a first die (not shown to simplify the drawing) and the second GRIN coupler 200b can be disposed on a second die (also not shown). The first die can be flip-chip bonded to the second die. Instead of evanescent coupling, as depicted in FIG. 1A, an optical mode can couple from a first optical waveguide 202a on the first die through the first tapered core segment 210a and first slotted core segment 220a to the first GRIN stack 230a, be launched by the first GRIN stack 230a and received by the second GRIN stack 230b, where it then couples to a second optical waveguide 202b on the second die through the second slotted core segment 220b and second tapered core segment 210b.

FIG. 3B illustrates a die-to-die optical coupling arrangement in elevation view and shows portions of the first die 310a and the second die 310b. Either or both of the first die 310a and the second die 310b can be a photonic integrated circuit, an optical interposer, an opto-electronic die, a semiconductor laser die, or other die comprising at least one optical waveguide. When a top oxide layer is used in the GRIN stacks 230a, 230b, each GRIN stack 230a on the first die 310a can form an oxide-to-oxide bond with an oxide surface layer (e.g., a passivating oxide layer) on the second die 310b, and each GRIN stack 230b on the second die 310b can form an oxide-to-oxide bond with an oxide surface layer on the first die 310a. The oxide-to-oxide bonding of the GRIN stacks can be used, at least in part, to bond the first die 310a to the second die 310b.

There can be several benefits to using GRIN couplers 200 for die-to-die optical coupling. The GRIN couplers 200 have more relaxed alignment tolerances than vertical evanescent couplers because of the expanded mode size in the GRIN stack 230. For example, up to 10 microns of misalignment in the lateral direction (y direction in the drawing of FIG. 3A) incurs an added coupling loss on the order of 1 dB for the GRIN couplers 200. In the vertical direction (z direction), a misalignment of up to 2 microns incurs about 1 dB of added loss. In practice, vertical alignment can be more precise than lateral alignment and essentially self-aligning for flip-chip bonding (such as in FIG. 3A and FIG. 3B), because heights of materials added to a substrate and etch depths can be controlled very precisely (e.g., to within less than 50 nm). The GRIN couplers 200 can also allow a larger gap (up to 10 microns in the x direction) between the GRIN stacks 230, again because of the expanded mode size in the GRIN stack 230 and also because the exiting mode can be significantly more collimated than an optical mode exiting from a narrow single-mode waveguide.

FIG. 3C plots results from a numerical simulation of optical mode coupling between GRIN couplers 200. The plot depicts optical intensity computed throughout two abutted GRIN couplers, as illustrated in the die-to-die optical coupling arrangement of FIG. 3A and FIG. 3B. The optical mode is first tightly confined vertically in the first slotted core segment 220a, expands vertically and downward (−z direction) through the first GRIN stack 230a, focuses vertically through the second GRIN stack 230b toward and into the second slotted core segment 220b.

FIG. 3D and FIG. 3E plot simulation results of optical coupling efficiency between two GRIN couplers 200 (similar to those depicted in FIG. 3A) as a function of misalignment in x, y, and z directions. A finite difference time domain (FDTD) simulation of the optical mode was carried out to evaluate the coupling efficiency for a mode launched from the first waveguide 202a, coupled through the first tapered core segment 210a, the first slotted core segment 220b, the first GRIN stack 230a, the second GRIN stack 230b, the second slotted core segment 220b, the second tapered core segment 210b, and coupled into the second waveguide 202b. The coupling efficiency represents a ratio of optical power coupled into the second waveguide 202b to optical power in the first waveguide 202a immediately prior to the first tapered core segment 210a.

The simulation results of FIG. 3D indicate that up to 10 microns of misalignment in x or y directions can be tolerated before incurring an additional loss of 1 dB. For this simulation, the GRIN stacks were both 40 microns wide and 10 microns tall. The simulation results of FIG. 3E indicate that up to 2 microns of misalignment in z can be tolerated before incurring an additional loss of 1 dB.

The relaxed alignment tolerances of optical couplers described above approach alignment tolerances typical for making electrical interconnects between dies using solder bumps or conductive pillars (such as occurs in flip-chip bonding and/or pick-and-place 2.5 D die assembly). The GRIN couplers 200 can also have considerably smaller footprints than conventional tapered evanescent vertical couplers. For example, the maximum extent of a GRIN coupler 200 can be no longer than 150 microns, allowing for x, y, and z alignment tolerances of up to 10 microns. However, smaller GRIN couplers 200 (e.g., having a maximum extent no greater than 75 microns or 100 microns) can be implemented if tighter alignment tolerances are used. Accordingly, electrical interconnects can be included on dies comprising GRIN couplers 200 and evanescent optical couplers 100 described above.

FIG. 4A illustrates an example of a flip-chip coupling arrangement in which optical coupling and electrical interconnects are made between two dies. In this example, the first die 410 comprises an optical interposer and the second die 420 comprises a photonic integrated circuit (PIC). An evanescent optical coupler 100 is used to couple light from a first waveguide 412 (comprising SiN or SiON) in oxide on the first die 410 to a second waveguide 422 (comprising silicon) in an oxide layer on the second die 420. The first die 410 can be bonded to the second die 420 using hydrophilic properties of oxide at the surface of each die (e.g., using optical contact bonding).

Light can be coupled into the first waveguide 412 on the first die 410 from a single-mode optical fiber 440. The optical fiber 440 can be mounted on a third die 430 which may or may not comprise semiconductor material. The third die 430 can include a V-groove in which the optical fiber 440 is mounted. Optical coupling from the fiber to the first waveguide 412 can be implemented with a GRIN coupler 200. For such coupling, the optical fiber 440 on the third die 430 is brought into alignment and close proximity (e.g., within 10 microns) to the GRIN coupler 200, such that the optical fiber 440 butt couples to the GRIN coupler 200.

Also disposed on the first die 410 and second die 420 are conductive nanopillars 416, 426 to make electrical connections between the two dies. The conductive nanopillars 416, 426 can comprise copper and can be recessed into each die. In some implementations, mating holes can be etched into each die before the dies are bonded, the conductive nanopillars 416, 426 can be deposited to fill or overfill the holes, and the surface planarized (e.g., with a chemical-mechanical polishing step) so that the conductive nanopillars are flush with the surface of the die. The mating holes can be patterned such that when the two dies are flip-chip bonded, the mating holes and conductive nanopillars 416, 426 align to each other, as depicted in FIG. 4A. In a same bonding process step, electrical die-to-die coupling and optical die-to-die coupling can be achieved using conductive nanopillars 416, 426 and an evanescent optical coupler 100. Oxide bonding can hold the dies together in addition to bonding between the copper bumps.

In some implementations, the conductive nanopillars 416, 426 on each die can have a height no greater than 2 microns in some cases, no greater than 1 micron in some cases, and even no greater than 0.5 micron in some cases. The pitch of the conductive nanopillars can be as small as 2 microns in some cases, as small as 1 micron in some cases, and even as small as 0.5 micron in some cases.

FIG. 4B illustrates optical and electrical die-to-die coupling in another implementation of flip-chip coupling. The implementation is similar to that of FIG. 4A, except a thin conductive film 450 is used between a first micro-scale conductive pad 415 on the first die 410 and a second micro-scale conductive pad 425 on the second die 420. The diameters of the micro-scale conductive pads 415, 425 can be no greater than 2 microns (e.g., from 0.1 micron to 2 microns or any subrange therebetween) or even no greater than 1 micron. The thin conductive film 450 can comprise a soft and/or malleable metal or metal alloy, or a conductive metal or metal alloy that can be softened by heat when bonding the two dies. The thin conductive film 450 can have a thickness no greater than 1 micron. In the illustration, the thin conductive film 450 comprises a gold-tin (AuSn) alloy. For the example bonding of FIG. 4B, an adhesive 460 (e.g., an optical epoxy) is also applied between the two dies (either prior to establishing optical and electrical coupling or after establishing optical and electrical coupling). The refractive index of the adhesive can have a value from approximately or exactly 1.45 to approximately or exactly 1.6.

FIG. 5 illustrates optical and electrical die-to-die coupling in another implementation of flip-chip coupling. Optical die-to-die coupling is achieved with an evanescent optical coupler 100, as in the example of FIG. 4A. Conductive micropillars 516 and contact pads 526 can be used to establish electrical interconnection between the two dies 410, 420 of FIG. 5. The contact pads 526 can comprise multiple layers of conductive metals (titanium, nickel, and gold in this example) and be disposed on the surface of one of the dies (the PIC die 420 in this example). The contact pads 526 may or may not be recessed into the surface of the second die 420. Conductive micropillars 516 can be patterned on the other die such that they align to the conductive pads 526 when the two dies are flip-chip bonded. The conductive micropillars 516 can be formed from a combination of materials, as illustrated in FIG. 5, though fewer, more, and/or different conductive materials can be used. In the illustrated example, the micropillar 516 comprises a copper body 515 which is deposited in a recess 411 of the first die 410. The copper body 515 is formed on a pillar pad 512 (which can also comprise multiple layers of conductive metals, as depicted). The titanium layer can provide good adhesion to the oxide for the pillar pad 512 and the conductive pad 526. The micropillar 516 can further include a nickel layer 517 and contact cap 519 disposed on the nickel layer 517. The contact cap 519 can be a semi-malleable metal or alloy (e.g., SnAgCu) or a metal or metal alloy that can be softened by heat when bonding the two dies. The contact cap 519 can provide intimate contact and electrical connection to the conductive pad 526. There can be a plurality of micropillars 516 and mating conductive pads 526 distributed across each die 410, 420. The height of the micropillars 516 can be from 5 microns to 15 microns. The width of each micropillar can be the same as the height of the micropillar, in some cases. A height-to-width aspect ratio of each micropillar 516 can be from 1:2 to 2:1. The depth of the recess(es) 411 and height of the conductive micropillars 516 can be controlled during microfabrication to provide a desired distance between optical coupling regions 110 on each die.

Prior to bonding the two dies, an adhesive 460 can be deposited on one die. The epoxy can have a refractive index from approximately or exactly 1.45 to approximately or exactly 1.6. The adhesive 460 can fill the recess 411 and gap between the coupling regions 110 on each die. According to some implementations, the two dies can be aligned with a pick-and-place tool or other aligner and once aligned, the epoxy can be cured. Optical coupling and electrical connections can be monitored during the alignment process before curing the adhesive 460. When a desired level of optical coupling and electrical connections have been verified, the adhesive 460 can be cured (e.g., with UV light or heat). As with the implementation of FIG. 4A and FIG. 4B, electrical die-to-die coupling and optical die-to-die coupling can be achieved, in a single bonding step, using conductive micropillars 516 and conductive pads 526 and an evanescent optical coupler 100.

The electrical interconnects described above in connection with FIG. 4A, FIG. 4B, and FIG. 5 can be used to establish electrical interconnections between circuitry disposed on the dies and/or substrates packaged together in a packaged device. The circuitry can include conductive traces, discrete electronic components, integrated circuits, IC chips, etc. The electrical interconnects can carry power, data, and/or other electrical signals.

Other implementations of electrical interconnects and optical coupling between two dies are possible. For example, the GRIN couplers 200 of FIG. 3A can be used in combination with the conductive nanopillars 416, 426 of FIG. 4A, the conductive pads 415, 425 and conductive film 450 of FIG. 4B, and/or conductive micropillars 516 and conductive pads 526 of FIG. 5 to achieve both optical and electrical coupling between dies. In some cases, the micropillars 516 can be formed on the surface of one of the dies (rather than in a recess), since the GRIN couplers 200 can allow for a greater distance between the dies. In some implementations, the slotted core segment 220 of the GRIN coupler 200 can be used instead of, or in addition to, the tapered core segment 110a-1, 110a-2 of the evanescent optical coupler 100 to shorten the length of the long, tapered core segment 110b-1, 110b-2.

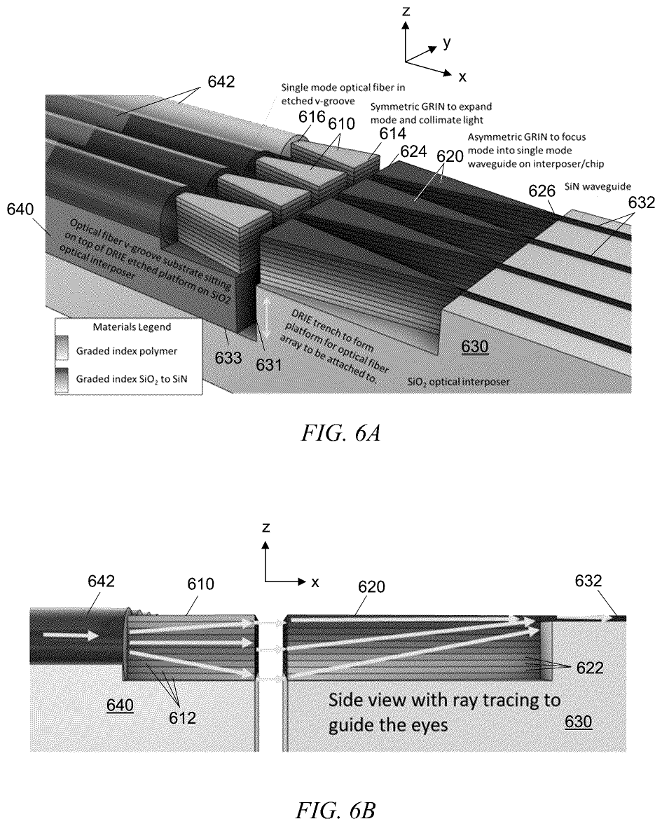

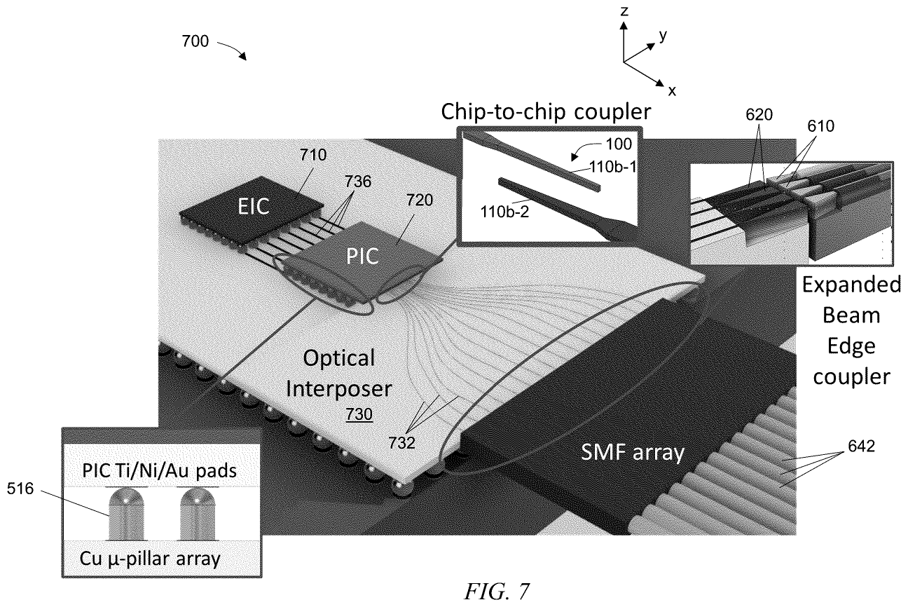

FIG. 6A and FIG. 6B illustrate (in perspective and elevation views, respectively) tapered GRIN couplers 610, 620 that can relax alignment tolerances for edge coupling between waveguides 632 on a first die 630 and single-mode optical fibers 642 mounted on a substrate or second die 640. For example, the lateral misalignment tolerance (in y and z directions of the drawing) between the exit face of one tapered GRIN coupler 610 and entrance face of a mating tapered GRIN coupler 620 can be up to 50 microns or more, making optical coupling between waveguides on a die and a matching array of single-mode optical fibers possible with current pick-and-place packaging tools (which are capable of two-sigma alignment accuracies of 3-10 microns). Because the optical beam exiting one tapered GRIN coupler 610, for example, and entering its mating GRIN coupler 620 can be collimated, or nearly collimated, the alignment tolerance in the third dimension (x in the drawing) can also be up to 50 microns. Such relaxing of alignment tolerances is a significant improvement over conventional edge-coupling and butt-coupling schemes that have alignment tolerances of 2.5 microns or less.

FIG. 6B is an elevation view of the optical coupling arrangement of FIG. 6A. The tapered GRIN couplers 610, 620 provide for beam expansion or reduction (depending on the propagation direction of light passing through the tapered GRIN couplers). In FIG. 6B, the direction of light propagation is from left to right, indicated by the light-shaded arrows, though light could equally as well propagate from right to left. In another implementation, GRIN couplers 200 of FIG. 2A can be used instead of tapered GRIN couplers 620 on the first die 630 to couple light to and from the waveguides 632 on the first die 630.

Each tapered GRIN coupler 610 on the second die 640 comprises multiple layers 612 of one or more materials in a stack, which may be referred to as a “GRIN stack” or “stack.” At least some of the layers within the GRIN stack have different refractive index values from other layers in the stack. Layers in the middle of the stack can have higher refractive index values than layers near the top and bottom of the GRIN stack. Since the optical mode in the optical fiber 642 is typically symmetric about a central optical axis of the fiber, the refractive index values of the multiple layers 612 can be approximately symmetrically distributed about the mid-height of the stack. For example, refractive index values of the layers can step down from a highest index value of a middle layer, or middle two layers, in a same way whether moving away from the middle layer(s) toward the bottom of the stack (toward the surface of the second die 640, −z direction according to the drawing) or moving away from the middle layer(s) toward the top of the stack of multiple layers 612 (+z direction). Because of the distribution of refractive index values, the optical mode in the tapered GRIN coupler 610 can be approximately symmetrical in two orthogonal directions (y and z in the drawings of FIG. 6A and FIG. 6B) that are transverse to the propagation of a mode through the tapered GRIN coupler 610, though the mode profile in one transverse direction (y, for example) may or may not be the same as the mode profile in the other transverse direction (z).

The height of the GRIN stack can be from 50 microns to 200 microns, or any subrange therebetween. In some implementations, is from 75 microns to 125 microns. The length of the tapered GRIN coupler 610 (in the x direction of the drawing of FIG. 6B) can be from 100 microns to 400 microns, or any subrange therebetween (e.g., from 150 microns to 300 microns).

The shape of the tapered GRIN coupler 610 tapers from a wide end 614 of the GRIN stack to a narrow end 616 of the GRIN stack. The wide end 614 can be an end from which light exits the tapered GRIN coupler 610 and/or enters the tapered GRIN coupler. The width of the wide end can be from 50 microns to 200 microns, or any subrange therebetween. In some implementations, the width of the wide end is from 75 microns to 125 microns. The narrow end can be arranged to couple light between the core of the optical fiber 642 and the tapered GRIN coupler 610. The width of the narrow end 616 can be from 5 microns to 25 microns, or any subrange therebetween.

The multiple layers 612 in the tapered GRIN coupler 610 can comprise polymeric material in some implementations, hard inorganic materials in some implementations, or a combination of polymeric materials and inorganic materials. An example polymer that may be used is poly(S—BOC) which is synthesized from t-BOC-protected poly(4-vinylthiophenol). The refractive index of this polymer can be controlled (by controlling a dose of ultraviolet light to which the polymer is exposed) over a range from 1.42 to 1.56 for a wavelength of approximately 1310 nm. Chemically amplified photoresists may also be suitable as a polymer for the tapered GRIN coupler 610. In some implementations, the multiple layers 612 can be 3D printed or formed using two-photon polymerization. Changing an amount of an additive to the polymer during the 3D-printing process can change the refractive index of each layer as it is printed. Examples of hard inorganic materials are oxides (e.g., silicon oxides, silicon oxynitrides, etc.).

Each tapered GRIN coupler 620 on the first die 630 also comprises multiple layers 622 of one or more materials in a GRIN stack of layers. At least some of the layers within the GRIN stack have different refractive index values from other layers in the stack. In this GRIN stack, a layer or layers nearest in height (z direction in the drawings) to the waveguide 632 on the first die 630 can have the highest value of refractive index in the stack. Refractive index values of adjacent layers in the GRIN stack may or may not step down in value asymmetrically about the layer or layers having the highest refractive index value, depending upon where the multiple layers 622 are located in z with respect to the waveguide 632. If the layer having the highest refractive index value is located at mid-height in the stack, then the refractive index values of other layers in the stack may step down symmetrically in either direction (±z from the middle layer or layers of highest index value). If the layer or layers of highest index value are located near the top or bottom of the stack, then the refractive index values of other layers in the stack may step down asymmetrically in either direction (±z from the layer or layers of highest index value). For example, the waveguide 632 can be located nearest a top layer of the GRIN stack, as depicted in FIG. 6B. Thus, the top layer or layers of the GRIN stack can have the highest value of refractive index in the stack and the refractive index values for other layers in the stack can step down in value on one side of the top layer, moving away from the top layer to the bottom layer of the GRIN stack. Asymmetry in the distribution of refractive index values can produce an asymmetric mode profile in the vertical direction (z direction in the drawing of FIG. 6B). For the example implementation of FIG. 6A and FIG. 6B, the waveguide 632 on the first die 630 is located near the top of the GRIN stack.

The height of the tapered GRIN coupler 620 on the first die 630 can be from 50 microns to 200 microns, or any subrange therebetween. In some implementations, the height of the tapered GRIN coupler is from 75 microns to 125 microns. The length of the tapered GRIN coupler 620 (in the x direction of the drawing of FIG. 6B) can be from 200 microns to 700 microns, or any subrange therebetween (e.g., from 300 microns to 600 microns).

The shape of the tapered GRIN coupler 620 tapers from a wide end 624 of the GRIN stack to a narrow end 626 of the GRIN stack. The wide end 624 can be an end from which light exits the tapered GRIN coupler 620 and/or enters the tapered GRIN coupler. The width of the wide end can be from 50 microns to 200 microns, or any subrange therebetween. In some implementations, the width of the wide end is from 75 microns to 125 microns. The narrow end can be arranged to couple light between the waveguide 632 on the first die 630 and the tapered GRIN coupler 620. The width of the narrow end 626 can be from 0.5 microns to 5 microns, or any subrange therebetween.

The multiple layers 622 in the tapered GRIN coupler 620 can comprise polymeric material in some implementations, hard inorganic materials in some implementations, or a combination of polymeric materials and inorganic materials. Examples of hard inorganic materials are oxides (e.g., silicon oxides, silicon oxynitrides, etc.).

The first die 630 may or may not include a trench or recess 631 etched to a desired depth into the first die. The recess 631 can be etched by deep reactive ion etching (DRIE), for example. The etched recess 631 can provide a surface or platform 633 in the first die 630 on which the second die 640 can rest and bring the tapered GRIN couplers 610 on the second die 640 into vertical (z position), pitch (rotation about the y axis), and roll (rotation about the x axis) alignment with the tapered GRIN couplers 620 on the first die 630. In other implementations, the recess 631 may not be formed. Instead, the first die 630 and second die 640 can be brought together (edge-to-edge as depicted in FIG. 6B) and aligned such that a desired level of coupling efficiency or coupled optical power is obtained between the tapered GRIN couplers 620 on the first die 630 and the tapered GRIN couplers 610 on the second die 640. Then, the dies can be adhered in place and/or to each other (using epoxy or another adhesive, for example).

FIG. 7 depicts an example of how the optical couplers described above can be implemented in a package 700. The example package 700 includes three dies (an electronic integrated circuit (EIC) 710, a PIC 720, and an optical interposer 730) communicatively coupled together. An array of single-mode optical fibers 642 are edged coupled to the optical interposer 730 using the tapered GRIN couplers 610, 620 described above in connection with FIG. 6A and FIG. 6B. The PIC 720 optically couples to waveguides 732 of the optical interposer 730 using evanescent optical couplers 100 described above in connection with FIG. 1A and FIG. 1B. The PIC 720 electrically couples, in this example, to conductive traces 736 of the optical interposer 730 using conductive micropillars 516 described above in connection with FIG. 5. The EIC 710 (and the PIC 720) can electrically couple to the conductive traces 736 using any of the above-described die-to-die electrical coupling structure (e.g., conductive micropillars 516, conductive nanopillars 416, 426, and conductive pads 415, 425 and conductive film 450).

The package 700 can have a higher density of electrical connections due to the small size of the conductive micropillars and conductive nanopillars (on the order of 10-micron diameter or less) compared to solder bumps used in conventional packaging. The solder bumps can have diameters exceeding 100 microns when the dies are bonded. Because the conductive micropillars and conductive nanopillars can have a height of about 20 microns or significantly less, only shallow trenches or recesses 411 can be etched in the optical interposer 730, for example, to recess the conductive micropillars and conductive nanopillars so that tapered core segments 110b-1, 110b-2 of the evanescent optical coupler 100 can be brought to within 3 microns of each other.

During assembly of the package 700, a top die (e.g., the PIC 720, which can have contact pads 526 with a thin Au top layer) can be placed in rough alignment (with a pick-and-place die bonding tool) with the lower die (optical interposer 730 in this example) such that the Au pads touch the contact caps 519 of the conductive micropillars 516 in the micropillar array on the lower die. The two dies can then be heated above the melting temperature of the material used to form the contact caps 519 such that the contact caps melt and wet the contact pads 526. As each contact cap 519 wets its mating contact pad 526, it increases its surface area (and thus its surface energy). After wetting, to reduce its surface energy, the contact cap 519 will then attempt to form an approximately spherical droplet. This re-shaping exerts a restorative force on the upper die and pulls the upper die into alignment with the lower die. When the contact caps 519 pull the contact pads 526 (and upper die) into alignment with the conductive micropillars 516 of the lower die, this self-aligning process can adequately align tapered core segment 110b-1 of the upper die (PIC 720 in this example) to tapered core segments 110b-2 of the lower die (optical interposer 730 in this example) to provide adequate optical coupling in coupling regions of evanescent optical couplers 100 elsewhere in the package 700.

A different assembly process can be used when conductive nanopillars 416, 426 are used instead of conductive micropillars 516. Because of their smaller size (down to 500 nm diameter or less), an even higher density of electrical interconnects can be achieved with conductive nanopillars 416, 426. Because of their short height (e.g., down to 250 nm or less) and no use of solder, an etch to recess the conductive nanopillars 416, 426 can be omitted in some cases. For example, the conductive nanopillars 416, 426 can be formed on the surface of the upper die and lower die and still allow (when brought into contact) the tapered core segments 110b-1, 110b-2 of the evanescent optical coupler 100 to be brought within 3 microns of each other. The assembly process can involve a hybrid bonding process. First, the oxide surfaces of the two dies that will contact each other can be cleaned with a plasma cleaner, which is a common tool in a CMOS foundry. The plasma cleaning activates the oxide surfaces and makes them hydrophilic. The hydrophilic nature of the oxide surfaces allows them to form a strong bond at room temperature and in ambient environment without any force applied between the two dies. The two dies are aligned carefully to one another, with an alignment tool having micron or sub-micron alignment accuracy, and brought into contact. The oxide bond between the dies can hold them together in an aligned configuration so the dies can be placed in an oven for an anneal step.

The bonded dies can then be annealed at 150-200 C so that the conductive nanopillars 426 on the upper die and conductive nanopillars 416 on the lower die (which are in contact, but not bonded) can fuse together. During the anneal, Cu atoms (for the illustrated example of FIG. 4A) diffuse from one conductive nanopillar to the other and form a strong bond and electrical connection between the two conductive nanopillars 416, 426. The combination of the oxide bond and conductive nanopillar bond provides good adhesion between the two dies. The lack of solder between the conductive nanopillars 416, 426 can be beneficial for signal transmission since solder can undesirably attenuate signals. In this assembly process, an adhesive (such as epoxy) is not used.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An evanescent optical coupler comprising:
a first tapered core segment optically coupled to a first single-mode optical waveguide at a first end of the first tapered core segment, wherein:
the first tapered core segment has a first taper angle, the first taper angle defining a first angle at which a sidewall of the first tapered core segment angles toward a central axis of the first tapered core segment, and
the first tapered core segment and the first single-mode optical waveguide are integrated onto or within a first die; and
a second tapered core segment optically coupled to the first tapered core segment at a second end of the first tapered core segment and integrated onto or within the first die, the second tapered core segment having a first terminating end that is not connected to another optical waveguide on the die, wherein the second tapered core segment has a second taper angle that is different than the first taper angle, the second taper angle defining an angle at which a sidewall of the second tapered core segment angles toward a central axis of the second tapered core segment.

2. The evanescent optical coupler of claim 1 in combination with the first die, wherein the first die is an optical interposer.

3. The evanescent optical coupler of claim 1, in combination with the first die, wherein the first die is a photonic integrated circuit die.

4. The evanescent optical coupler of claim 1, further comprising:
a third tapered core segment optically coupled to a second single-mode optical waveguide at a first end of the third tapered core segment, wherein:
the third tapered core segment has a third taper angle, the third taper angle defining a third angle at which a sidewall of the third tapered core segment angles toward a central axis of the third tapered core segment, and
the third tapered core segment and the second single-mode optical waveguide are integrated onto or within the first die; and
a fourth tapered core segment optically coupled to the third tapered core segment at a second end of the third tapered core segment and integrated onto or within the first die, the fourth tapered core segment having a second terminating end that is not connected to another optical waveguide on the first die, wherein:
the fourth tapered core segment has a fourth taper angle that is different than the third taper angle,
the fourth taper angle defines an angle at which a sidewall of the fourth tapered core segment angles toward a central axis of the fourth tapered core segment, and
the fourth tapered core segment is spaced a distance g from the second tapered core segment such that evanescent optical coupling between the second tapered core segment and the fourth tapered core segment occurs when an optical mode propagates along the second tapered core segment.

5. The evanescent optical coupler of claim 1, further comprising:
a third tapered core segment optically coupled to a second single-mode optical waveguide at a first end of the third tapered core segment, wherein:
the third tapered core segment has a third taper angle, the third taper angle defining a third angle at which a sidewall of the third tapered core segment angles toward a central axis of the third tapered core segment, and
the third tapered core segment and the second single-mode optical waveguide are integrated onto or within a second die that is bonded to the first die; and
a fourth tapered core segment optically coupled to the third tapered core segment at a second end of the third tapered core segment and integrated onto or within the second die, the fourth tapered core segment having a second terminating end that is not connected to another optical waveguide on the second die, wherein:
the fourth tapered core segment has a fourth taper angle that is different than the third taper angle,
the fourth taper angle defines an angle at which a sidewall of the fourth tapered core segment angles toward a central axis of the fourth tapered core segment, and
the fourth tapered core segment is spaced a distance g from the second tapered core segment such that evanescent optical coupling between the second tapered core segment and the fourth tapered core segment occurs when an optical mode propagates along the second tapered core segment.

6. The evanescent optical coupler of claim 5, wherein:
the first single-mode optical waveguide comprises silicon; and
the second single-mode optical waveguide comprises silicon nitride or silicon oxynitride.

7. The evanescent optical coupler of claim 5 in combination with the first die and the second die, wherein:
the first die comprises a photonic integrated circuit; and
the second die comprises an optical interposer.

8. The evanescent optical coupler of claim 5 in combination with the first die and the second die, further comprising:
at least one electrical interconnecting structure electrically coupling circuitry on the first die to circuitry on the second die.

9. The evanescent optical coupler of claim 8, wherein the at least one electrical interconnecting structure comprises:
a first conductive nanopillar disposed on a first surface of the first die; and
a second conductive nanopillar disposed on a second surface of the second die, wherein the first conductive nanopillar contacts the second conductive nanopillar and is fused to the second conductive nanopillar.

10. The evanescent optical coupler of claim 8, wherein the at least one electrical interconnecting structure comprises:
a first conductive pad disposed on one of a first surface of the first die or on a second surface of the second die; and
a micropillar disposed on the other of the first surface of the first die or the second surface of the second die, wherein the micropillar contacts the conductive pad.

11. The evanescent optical coupler of claim 8, wherein the at least one electrical interconnecting structure comprises:
a first conductive pad disposed on a first surface of the first die;
a second conductive pad disposed on a second surface of the second die; and
a film of solder disposed between the first conductive pad and the second conductive pad, the film of solder having a thickness no greater than 1 micron.

12. A slotted graded refractive index (GRIN) coupler comprising:
a tapered core segment optically coupled to a single-mode waveguide;
a slotted core segment optically coupled at a first end to the tapered core segment, the slotted core segment comprising a plurality of slotted voids formed in or through the slotted core segment; and
a GRIN stack optically coupled at a first end to a second end of the slotted core segment, the GRIN stack comprising a plurality of layers of one or more materials, wherein at least two layers of the plurality of layers of one or more materials have different values of refractive index.

13. The slotted GRIN coupler of claim 12, wherein the plurality of slotted voids comprises at least:
a first pair of slotted voids; and
a second pair of slotted voids, wherein:
each first slotted void of the first pair of slotted voids has a same first length that is greater than a first width of the first slotted void, and
each second slotted void of the second pair of slotted voids has a same second length that is greater than a second width of the second slotted void, wherein
the plurality of slotted voids are arranged across the slotted core segment to focus an optical mode traveling through the slotted core segment into the tapered core segment.

14. The slotted GRIN coupler of claim 12, wherein a core of the single-mode waveguide, the slotted core segment, and a layer of the plurality of layers are patterned in a single layer of material.

15. The slotted GRIN coupler of claim 12, wherein a core of the single-mode waveguide comprises silicon.

16. The slotted GRIN coupler of claim 12, wherein a core of the single-mode waveguide comprises silicon nitride or silicon oxynitride.

17. The slotted GRIN coupler of claim 12, wherein a length of the GRIN coupler is no greater than 75 microns.

18. A packaged device having an optical fiber coupled to an integrated optical waveguide on a die, the packaged device comprising:
a first tapered graded refractive index (GRIN) coupler disposed on a substrate and optically coupled to the optical fiber at a narrow end of the first tapered GRIN coupler; and
a second tapered GRIN coupler disposed on the die and optically coupled to the integrated optical waveguide at a narrow end of the second tapered GRIN coupler, wherein a wide end of the second tapered GRIN coupler is optically coupled to a wide end of the first tapered GRIN coupler and wherein the substrate is bonded to the die.

19. The packaged device of claim 18, wherein:
the first tapered GRIN coupler comprises a first stack of layers of one or more first materials;
at least a first layer in the first stack of layers nearest a core of the optical fiber has a highest first value of refractive index in the first stack of layers; and
first refractive index values of the layers in the first stack of layers step down from the first value of refractive index on either side of the at least first layer moving away from the at least first layer, such that an optical mode propagating through the first tapered GRIN coupler is symmetric in two orthogonal directions that are transverse to the direction of propagation of the optical mode through the first tapered GRIN coupler.

20. The packaged device of claim 19, wherein:
the second tapered GRIN coupler comprises a second stack of layers of one or more second materials;
at least a second layer in the second stack of layers nearest a core of the integrated optical waveguide has a highest second value of refractive index in the second stack of layers; and
refractive index values of the layers in the second stack of layers step down from the second value of refractive index on one side of the at least second layer moving away from the at least second layer, such that an optical mode propagating through the second tapered GRIN coupler is asymmetric in a direction that is transverse to the direction of propagation of the optical mode through the second tapered GRIN coupler.
